(19) United States
(12) Patent Application Publication
(10) Pub. No.: US 2010/0076763 A1
(43) Pub. Date: Mar. 25, 2010

(54) VOICE RECOGNITION SEARCH APPARATUS AND VOICE RECOGNITION SEARCH METHOD

(75) Inventors: Kazushige Ouchi, Saitama-shi (JP); Miwako Doi, Kawasaki-shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/559,878

(22) Filed: Sep. 15, 2009

(30) Foreign Application Priority Data
Sep. 22, 2008 (JP) P2008-242087

(51) Int. Cl. G10L 15/00; G10L 17/00; G10L 15/18; G10L 21/00

(52) U.S. Cl. 704/246; 704/257; 704/270; 704/E15.001; 704/E15.046; 704/E21.001

(57) ABSTRACT

A voice recognition search apparatus includes: a dictionary create unit creating a first voice recognition dictionary from a search subject data; a voice acquisition unit acquiring first and second voices; a voice recognition unit creating first and second text data by recognizing the first and second voices using the first and second voice recognition dictionaries; a first search unit searching the search subject data by the first text data; and a second search unit searching a search result of the first search unit by the second text data.

### CROSS REFERENCE TO RELATED APPLICATIONS AND INCORPORATED BY REFERENCE

The application is based upon and claims the benefit of priority from the prior Japanese Patent Applications No. P2008-242087, filed on Sep. 22, 2008; the entire contents of which are incorporated herein by reference.

### BACKGROUND OF THE INVENTION

1. Field of the Invention

The present invention relates to a voice recognition search apparatus and a voice recognition search method.

2. Description of the Related Art

There have been made efforts to search desired information and operate a car navigation system or the like by voice recognition input under circumstances where the car navigation system or the like cannot be manually operated. In the case of isolated word voice recognition, the number of vocabularies and a recognition rate are in a trade-off relationship. Hence, there has been considered a method for ensuring voice recognition accuracy by appropriately switching dictionaries in accordance with an attribute of inputted voice. For example, there is a method in which an instruction on an input attribute is first issued, an appropriate voice recognition dictionary is selected, and voice is then inputted (JP-A 2007-264198) Moreover, there is a method in which voice recognition for all the vocabularies is implemented, and in the case where candidates for a voice search key are many, a question related to determination of the voice search key is presented to a user to then let the user speak information related to the determination, and the candidate for the voice search key is determined based on a recognition likelihood of the voice search key and a recognition likelihood of such related information (JP 3420965).

For example, in a usage purpose for which a manual operation is possible, for example, such as programming to record a television program, in the case of using the voice recognition input in order to decrease an operation load of a remote controller or the like, it is considered that usability of a system as a whole is enhanced by appropriately combining the voice recognition input with a key operation more than by performing all the input by the voice recognition input. In this connection, an effort has been made, which is to program to record the program by the voice recognition by using an electronic program guide (EPG) in which a program table of television broadcasting is displayed on a screen (JP-A 2000-316128).

In the case of using the voice recognition input in the usage purpose for which the manual operation is possible, heretofore, a voice recognition dictionary prepared in advance has been used in a fixed manner. However, in accordance with this method, it has been difficult to maintain the voice recognition accuracy in search of information that changes daily, such as information regarding the program, and information on the Internet.

### SUMMARY OF THE INVENTION

An object of the present invention is to provide a voice recognition search apparatus and a voice recognition search method, which can improve a voice recognition accuracy in search of information that changes daily.

An aspect of the present invention inheres in a voice recognition search apparatus including: a search subject data storage unit configured to store search subject data being updated; a dictionary create unit configured to create a first voice recognition dictionary from the search subject data dynamically; a voice acquisition unit configured to acquire first and second voices; a voice recognition unit configured to create first text data by recognizing the first voice using the first voice recognition dictionary and converting the first voice into a text, and configured to create second text data by recognizing the second voice using a second voice recognition dictionary and converting the second voice into a text; a first search unit configured to search the search subject data by the first text data as a first search keyword; and a second search unit configured to search a search result of the first search unit by the second text data as a second search keyword.

Another aspect of the present invention inheres in a voice recognition search method including: creating a first voice recognition dictionary dynamically based on search subject data being updated sequentially stored in a search subject data storage unit; acquiring first and second voices; creating first text data by recognizing the first voice using the first voice recognition dictionary and converting the first voice into a text; creating second text data by recognizing the second voice using a second voice recognition dictionary and converting the second voice into a text; searching the search subject data by the first text data as a first search keyword; and searching a search result of the first search keyword by the second text data as a second search keyword.

### BRIEF DESCRIPTION OF DRAWINGS

FIG. 1 is a block diagram showing an example of a voice recognition search system according to an embodiment of a present invention.

FIG. 2 is a schematic view showing an example of an implemented remote controller according to the embodiment.

FIGS. 3 and 4 are block diagrams showing another examples of the voice recognition search system according to the embodiment.

FIG. 5 is a schematic view showing an example of EPG data according to the embodiment.

FIG. 6 is a schematic view showing an example of imparted phonetic readings of a program title according to the embodiment.

FIG. 7 is a schematic view showing an example of imparted phonetic readings of cast names according to the embodiment.

FIG. 8 is a schematic view showing an example of fixed vocabularies for categories according to the embodiment.

FIG. 9 is a schematic view showing an example of fixed vocabularies for dates and times according to the embodiment.

FIG. 10 is a schematic view showing an example of vocabularies for channels according to the embodiment.

FIG. 11 is a schematic view showing an example of a first voice recognition dictionary according to the embodiment.

FIG. 12 is a schematic view showing an example of display of voice recognition candidates according to the embodiment.

FIGS. 13 and 14 are schematic views showing examples of display of search results by a first search keyword according to the embodiment.

FIG. 15 is a schematic view showing an example of display of narrowed results according to the embodiment.

FIG. 16 is a flowchart showing an example of a voice recognition search method according to the embodiment.

FIG. 17 is a flowchart showing an example of a method for creating first and second voice recognition dictionaries according to the embodiment.

FIG. 18 is a schematic view showing an example of commercial article information data in Internet shopping according to other embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set fourth such as specific signal values, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail.

### (Voice Recognition Search System)

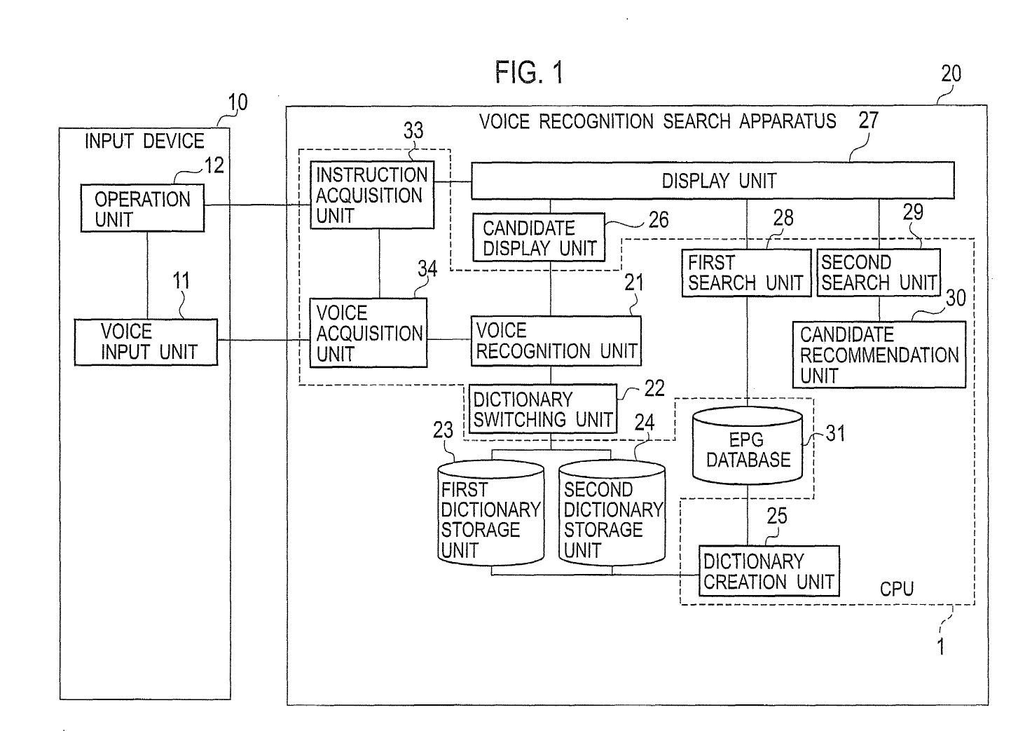

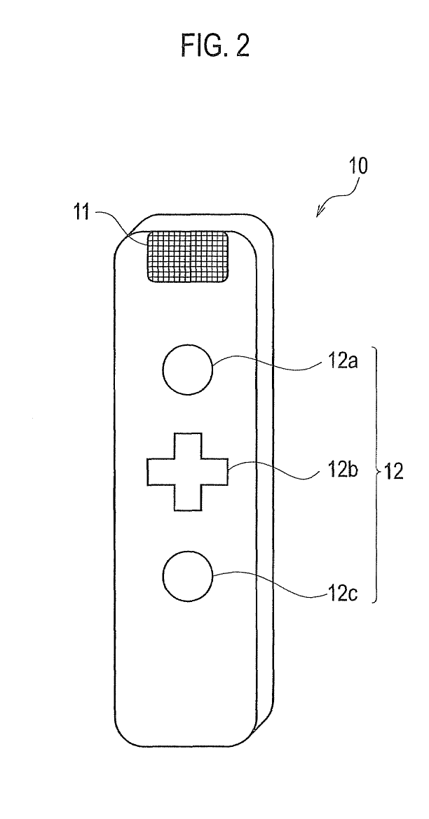

As shown in FIG. 1, a voice recognition search system according to an embodiment of the present invention includes an input device (remote controller) 10 and a voice recognition search apparatus 20. The voice recognition search apparatus 20 is an instrument provided with a recording function, such as a video hard disk recorder, and a television set or a personal computer, which is provided with the recording function. As shown in FIG. 2, the remote controller 10 includes a voice input unit 11 and an operation unit 12. The voice input unit may be built in an arbitrary position of the remote controller 10 as shown in FIG. 2, or may be attached as an external instrument to the remote controller 10. The operation unit 12 includes a cross key 12b and one or more push buttons 12a and 12c on arbitrary positions of the remote controller.

The operation unit 12 is not limited to this described arrangement, and may be configured to be capable of operating a pointer by a pointing device. Moreover, in the case where the voice recognition search apparatus 20 is the personal computer added with the recording function, the voice input unit 11 maybe connected to the personal computer, and an input device of the personal computer, such as a mouse, may be used as the operation unit 12.

The voice recognition search apparatus 20 includes a central processing unit (CPU) 1, a search subject data storage unit (EPG database) 31, a first dictionary storage unit 23, a second dictionary storage unit 24, a candidate display unit 26, and a display unit 27. The CPU 1 logically includes an instruction acquisition unit 33, a voice acquisition unit 34, a voice recognition unit 21, a dictionary switching unit 22, a dictionary creation unit 25, a first search unit 28, a second search unit 29 and a candidate recommendation unit 30 as modules (logic circuits) which are hardware resources.

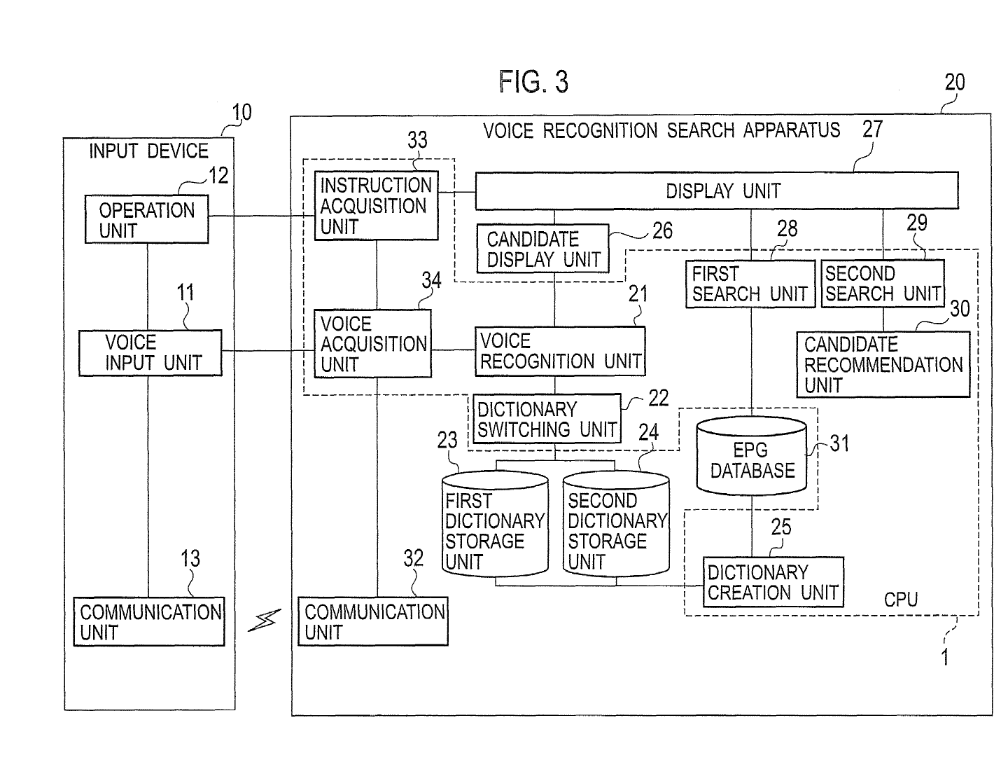

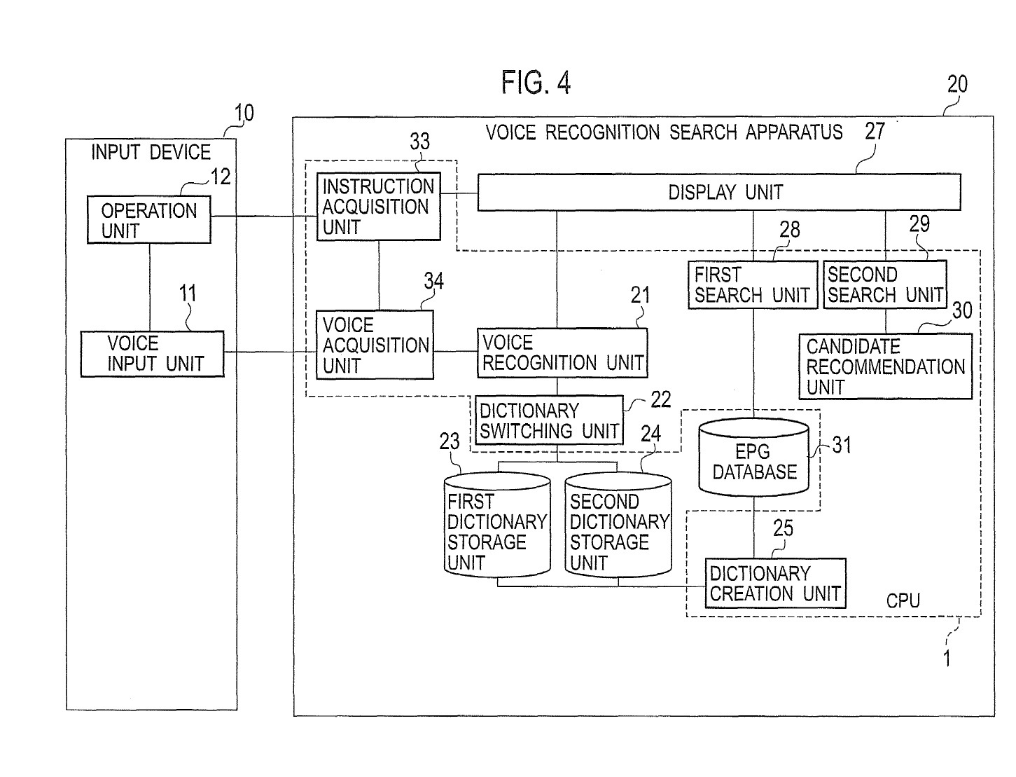

FIG. 1 shows the case where the remote controller 10 and the voice recognition search apparatus 20 are connected to each other by wires; however, as shown in FIG. 3, a configuration may be adopted, in which the remote controller 10 and the voice recognition search apparatus 20 include communication units 13 and 32, respectively, and are capable of wirelessly communicating with each other. Moreover, as shown in FIG. 4, the candidate display unit 26 shown in FIG. 1 may be omitted, and the display unit 27 may also serve as the candidate display unit 26 in terms of function. It is possible to embody other configurations in FIGS. 3 and 4 by substantially similar configurations to those in FIG. 1. Accordingly, a description will be made below of the system by using FIG. 1.

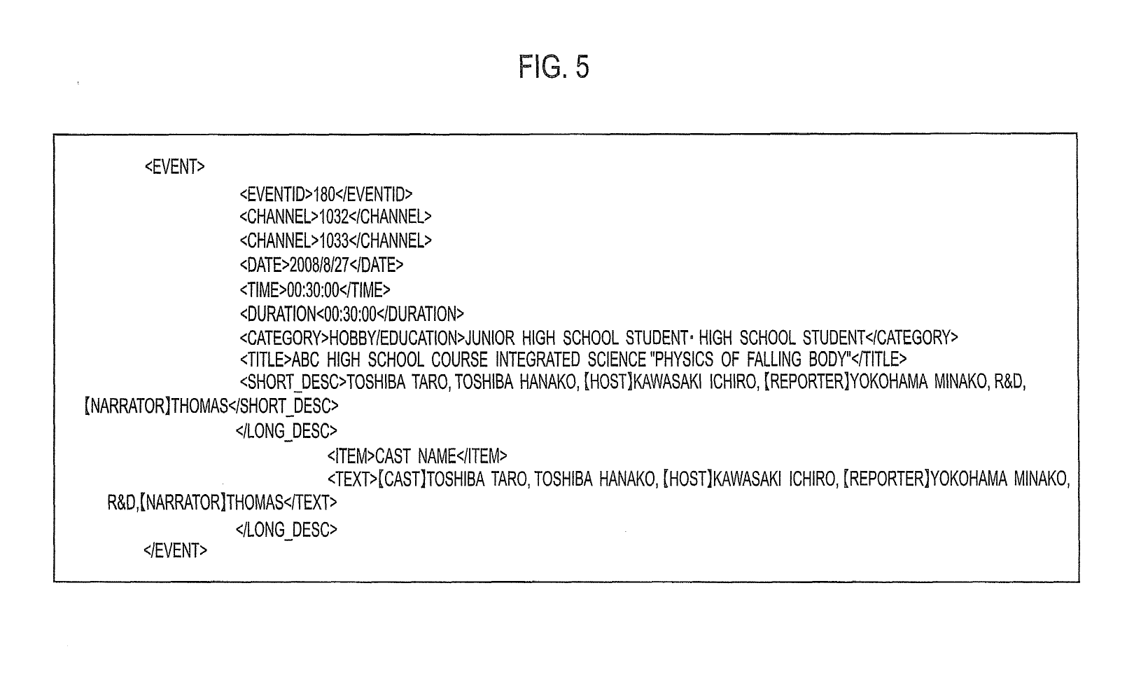

In the EPG database 31, EPG data (search subject data) sequentially updated in digital terrestrial television broadcasting or the like is stored. The EPG data includes information regarding a broadcast channel, a broadcast start time, a broadcast end time, a category, a program title, cast names and the like for each program. FIG. 5 shows an example of the EPG data for one program. In this example, the EPG data is data in an extensible markup language (XML) format; however, the EPG data may be data in which a format is not the XML, such as an Internet electronic program guide (iEPG). In the case of the data in the XML format, it is desirable that the EPG database 31 be constructed of an XML database; however, may be constructed of other databases such as a relational database (RDB).

The dictionary creation unit 25 analyzes the EPG data stored in the EPG database 31, for example, at a frequency of once a day, and dynamically creates a first voice recognition dictionary, which is used at the time of the voice recognition, in response to contents of the EPG data.

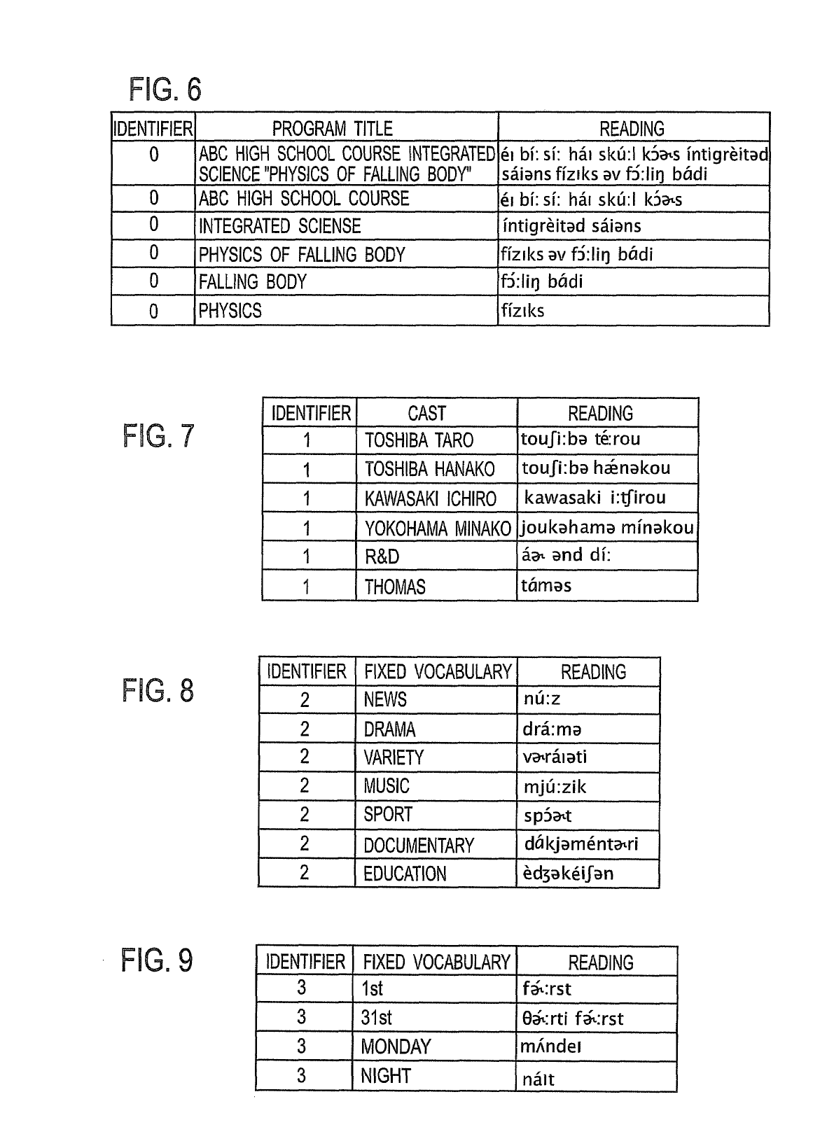

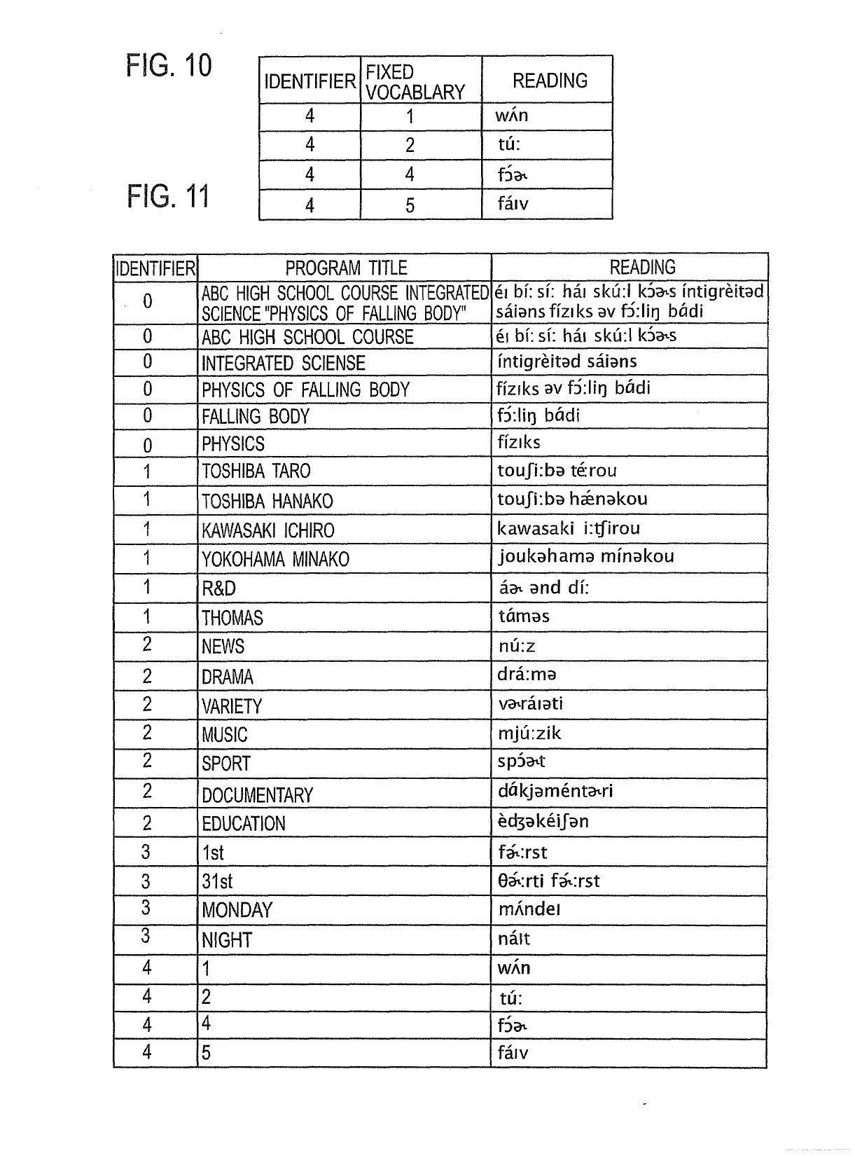

Here, a description will be made of an example of a creation method of the first voice recognition dictionary. The program title enclosed by <TITLE> tags, which is as shown in FIG. 5, and the cast names enclosed by <TEXT> tags next to <ITEM> CAST NAME </ITEM>, which are also as shown in FIG. 5, are extracted from among the EPG data stored in the EPG database 31. Some program titles are quite long unless abbreviated, and include subtitles. Accordingly, for example as shown in FIG. 6, a character string is divided by using, as cues, spaces, parentheses and postpositional particles (for example, “no” and the like in Japanese) extracted by a morphological analysis. Here, the spaces, the parentheses and the positional particles are those included in the program title. Then, identifiers and phonetic readings are imparted to these respective elements. As shown in FIG. 7, identifiers and phonetic readings are also imparted to the cast names. Moreover, in order to decrease the number of vocabularies, overlapping vocabularies having the same phonetic readings are deleted from the extracted program title and cast names if the overlapping vocabularies are present therein. Furthermore, fixed vocabularies of the categories, the times, the channel names and the like, which are as shown in FIGS. 8 to 10, respectively, and are not be extracted from the program title or the cast names, are added to the first voice recognition dictionary together with identifiers and phonetic readings. The fixed vocabularies of the categories, the times, the channel names and the like just need to be prestored in the EPG database 31 or the like. As a result, the first voice recognition dictionary is created as shown in FIG. 11, and the first voice recognition dictionary stored in the first dictionary storage unit 23 is updated. Such update processing of the first voice recognition dictionary, which is described above, is implemented periodically, for example, at a midnight or the like once a day, and the first voice recognition dictionary that is based on the up-to-date EPG data is dynamically created.

The voice acquisition unit 34 acquires voice inputted from the voice input unit 11 to the input device 10. The instruction acquisition unit 33 acquires a variety of instructions inputted from the operation unit 12 to the input device 10.

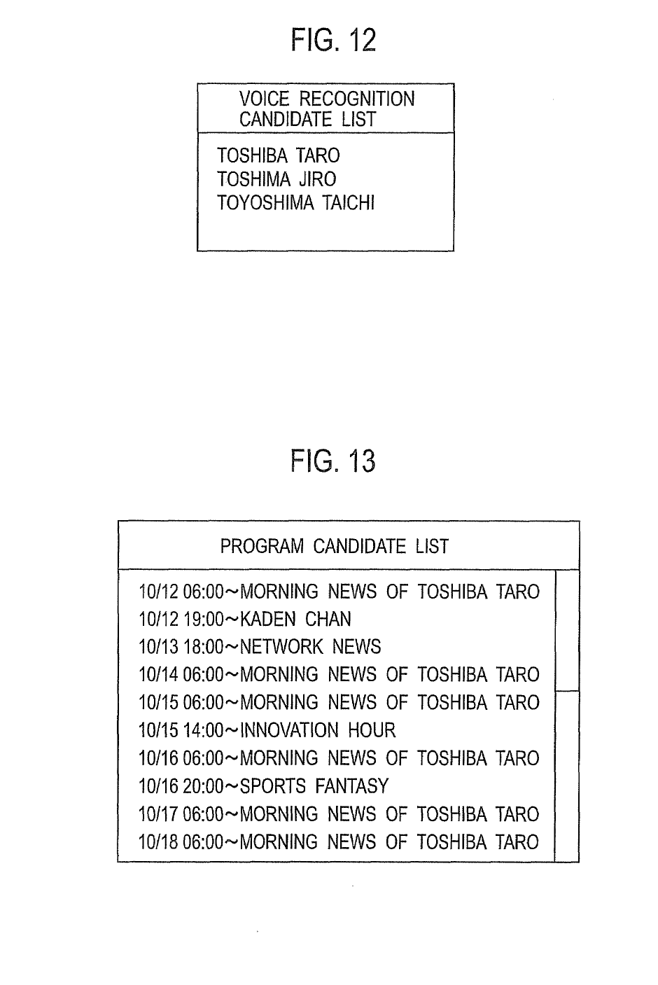

The voice recognition unit 21 performs the voice recognition for first voice, which is acquired by the voice acquisition unit 34, by using the first voice recognition dictionary stored in the first dictionary storage unit 23, converts the first voice into text to thereby create first text data, and allows the candidate display unit 26 to display the first text data thereon. In the case where a plurality of voice recognition candidates (first text data) are extracted, the voice recognition unit 21 allows the candidate display unit 26 to display the voice recognition candidates thereon in order from one having a higher likelihood. For example, in the case where a user speaks “Toshiba Taro”, then three voice recognition candidates are extracted as shown in FIG. 12. As shown in FIG. 12, both of the voice recognition candidates and phonetic readings thereof are displayed. Then, the user can recognize and easily understand why these voice recognition candidates are listed up. If a desired voice recognition candidate is present among the voice recognition candidates displayed on the candidate display unit 26, then the user can select the desired voice recognition candidate by the operation unit 12.

The first search unit 28 searches the EPG data, which is stored in the EPG database 31, for the desired voice recognition candidate (for example, “Toshiba Taro”) as a first search keyword, which is acquired by the instruction acquisition unit 33. Then, the first search unit 28 allows the display unit 27 to display a program candidate list (search results), in which the first search keyword is included, thereon as shown in FIG. 13. Here, the first search unit 28 determines whether the first search keyword is the cast name or a part thereof or the program title or a part thereof based on the identifier of the first search keyword. In the case where it is determined that the first search keyword is the cast name or a part thereof, the <TEXT> tags which follow <ITEM> CAST NAME </ITEM> shown in FIG. 5 are searched for, and in the case where it is determined that the first search keyword is the program title or a part thereof, the <TITLE> tags are searched for. Then, the program broadcast date and time, the channel, the program title and the like are extracted for each program candidate from the EPG data of the hit programs, and the program candidate list is created.

Note that, in the case where the voice recognition unit 21 extracts one voice recognition candidate, or in the case where a threshold value is preset for the likelihoods, and by using the threshold value, it is determined that a likelihood of one voice recognition candidate is obviously higher than those of the other voice recognition candidates, then the first search unit 28 may immediately implement the search for the one voice recognition candidate taken as the first search keyword without waiting for the instruction acquisition unit 33 to acquire the desired voice recognition candidate. In this case, the first search unit 28 does not have to allow the display unit 27 to display the one voice recognition candidate thereon.

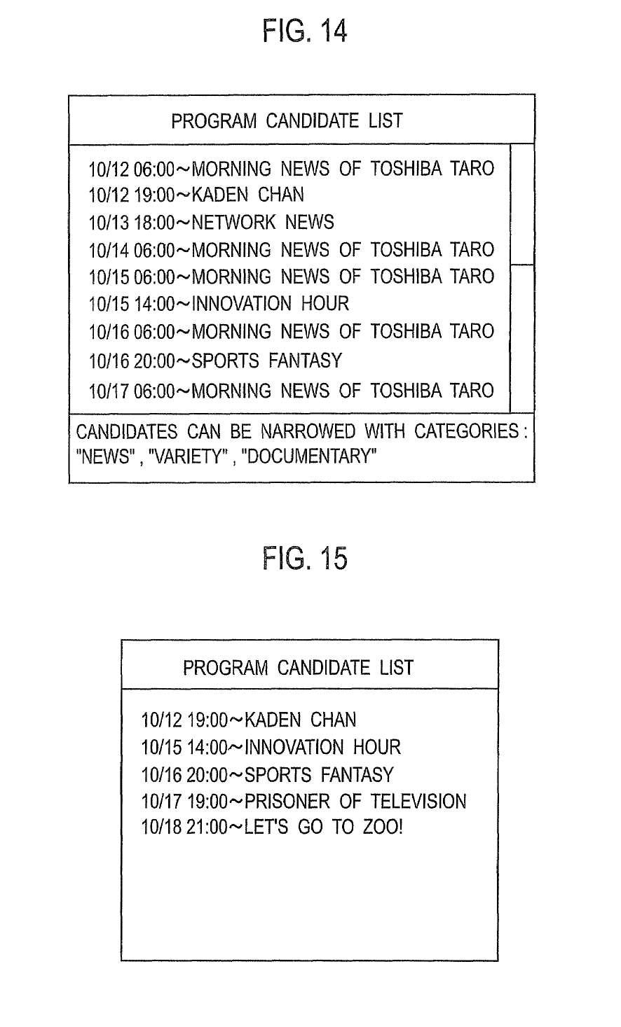

At the time when the program candidate list is displayed on the display unit 27 as shown in FIG. 13, the user can speak second voice in order to narrow the candidates, and can input the second voice to the voice input unit 11. Here, a case is considered where some users do not know how to speak at the time of narrowing the candidates. Accordingly, the candidate recommendation unit 30 analyzes the program candidate list created by the first search unit 28, and recommends narrowing candidates. For example, the candidate recommendation unit 30 may extract information regarding <CATEGORY> tags of the programs in the program candidate list, and may recommend/display information regarding categories effective for the narrowing as shown in a lower column of the program candidate list of FIG. 14. Moreover, it is preferable that the candidate recommendation unit 30 appropriately switch contents of such recommendation in response to the program candidate list created by the first search unit 28. For example, preferably, the candidate recommendation unit 30 recommends the user to narrow the candidates based on a date and a time in the case where a plurality of the same program titles are present, or recommends another cast name in the case where a cast of the other cast name is present.

The dictionary creation unit 25 further creates a second voice recognition dictionary from the program candidate list created by the first search unit 28. A creation method of the second voice recognition dictionary is different from that of the first voice recognition dictionary in the following point. Specifically, the first voice recognition dictionary is created from the programs in the EPG data of the EPG database 31, whereas the second voice recognition dictionary is created from the programs in the program candidate list created by the first search unit 28. Other procedures in the creation method of the second voice recognition dictionary are substantially similar to procedures in the creation method of the first voice recognition dictionary shown in FIG. 6. Accordingly, a duplicate description will be omitted. Since the second voice recognition dictionary requires a small scale as compared with the first voice recognition dictionary, the second voice recognition dictionary may register, as vocabularies, words extracted as nouns by performing the morphological analysis for program contents described in <SHORT_DESC> and <LONG_DESC> of the EPG data. Moreover, the second voice recognition dictionary may also register words of <CATEGORY>. Moreover, it is considered that the categories, the channels, the date and the time and the like are mainly used at the time of such narrowing search. Accordingly, fixed vocabularies of these may be prestored as the second voice recognition dictionary in the second dictionary storage unit 24, and the second voice recognition dictionary composed of the fixed vocabularies may be used in response to the contents of the program candidate list created by the first search unit 28. Furthermore, the dictionary creation unit 25 may create the second voice recognition dictionary by combining the vocabularies dynamically created from the program candidate list created by the first search unit 28 and the fixed vocabularies prestored in the second dictionary storage unit 24 with each other.

The voice recognition unit 21 further performs the voice recognition for the second voice (for example, “variety”), which is acquired by the voice acquisition unit 34, by using the second voice recognition dictionary. Then, the voice recognition unit 21 coverts the second voice into text to thereby create second text data, and allows the candidate display unit 26 to display the second text data thereon. In the case where a plurality of voice recognition candidates (second text data) are extracted, the voice recognition unit 21 allows the candidate display unit 26 to display the voice recognition candidates thereon in order from one having a higher likelihood. If a desired voice recognition candidate is present among the voice recognition candidates displayed on the candidate display unit 26, then the user can select the desired voice recognition candidate by the operation unit 12.

The second search unit 29 searches the program candidate list, which is created by the first search unit 28, for the desired voice recognition candidate (second text data) as a second search keyword, which is acquired by the instruction acquisition unit 33. Then, the second search unit 29 creates a program candidate list in which the second search keyword is included, and allows the display unit 27 to display the program candidate list thereon as shown in FIG. 15.

In the search performed by the first search unit 28 by using the first search keyword, a large number of program candidates are displayed as shown in FIG. 13, whereas the program candidates can be narrowed as shown in FIG. 15 by the narrowing search performed by the second search unit 29 by using the second search keyword. The user can select a desired program by a simple operation.

Note that, in the case where the voice recognition unit 21 extracts one voice recognition candidate, or in the case where a threshold value is preset for the likelihoods, and by using the threshold value, it is determined that a likelihood of one voice recognition candidate is obviously higher than those of the other voice recognition candidates, then the second search unit 29 may immediately implement the search for the one voice recognition candidate taken as the second search keyword without waiting for the instruction acquisition unit 33 to acquire the desired voice recognition candidate.

In this case, the second search unit 29 does not have to allow the display unit 27 to display the one voice recognition candidate thereon. In particular, the second voice recognition dictionary becomes smaller than the first voice recognition dictionary in terms of scale, and accordingly, it becomes frequent that the voice recognition unit 21 extracts one voice recognition candidate, and that the likelihood of one voice recognition candidate becomes obviously higher than those of the other voice recognition candidates. Therefore, it is expected that an operation burden of the user will be decreased.

After the program candidate list is created by the first search unit 28, the dictionary switching unit 22 switches the voice recognition dictionary from the first voice recognition dictionary to the second voice recognition dictionary. For example, at the time when the display unit 27 is allowed to display thereon the program candidate list created by the first search unit 28, the dictionary switching unit 22 switches the voice recognition dictionary, which is to be used when the voice recognition unit 21 performs the voice recognition, from the first voice recognition dictionary to the second voice recognition dictionary.

The first dictionary storage unit 23 stores the first voice recognition dictionary dynamically created by the dictionary create unit 25. The second dictionary storage unit 24 stores the second voice recognition dictionary dynamically created by the dictionary create unit 25 and the second voice recognition dictionary composed of the fixed vocabularies. For example, a memory, a magnetic disk, an optical disk or the like maybe used for the first dictionary storage unit 23 and the second dictionary storage unit 24.

The display unit 27 displays the program candidate list (search results) created by the first search unit 28, the program candidate list (search results) by the second search unit 29 or the like. The candidate display unit 26 displays voice recognition candidate or the like by the voice recognition unit 21. A liquid crystal display (LCD), a plasma display, CRT display or the like may be used for the display unit 27 and the candidate display unit 26.

### (Voice Recognition Search Method)

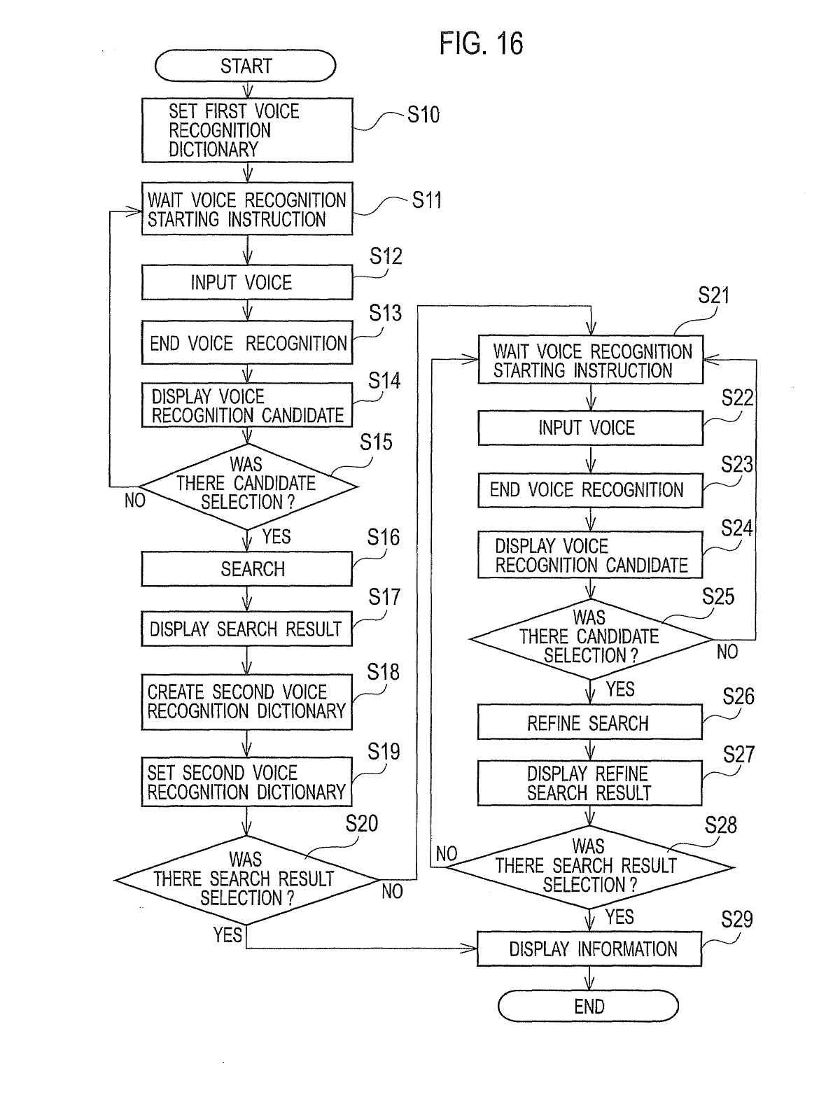

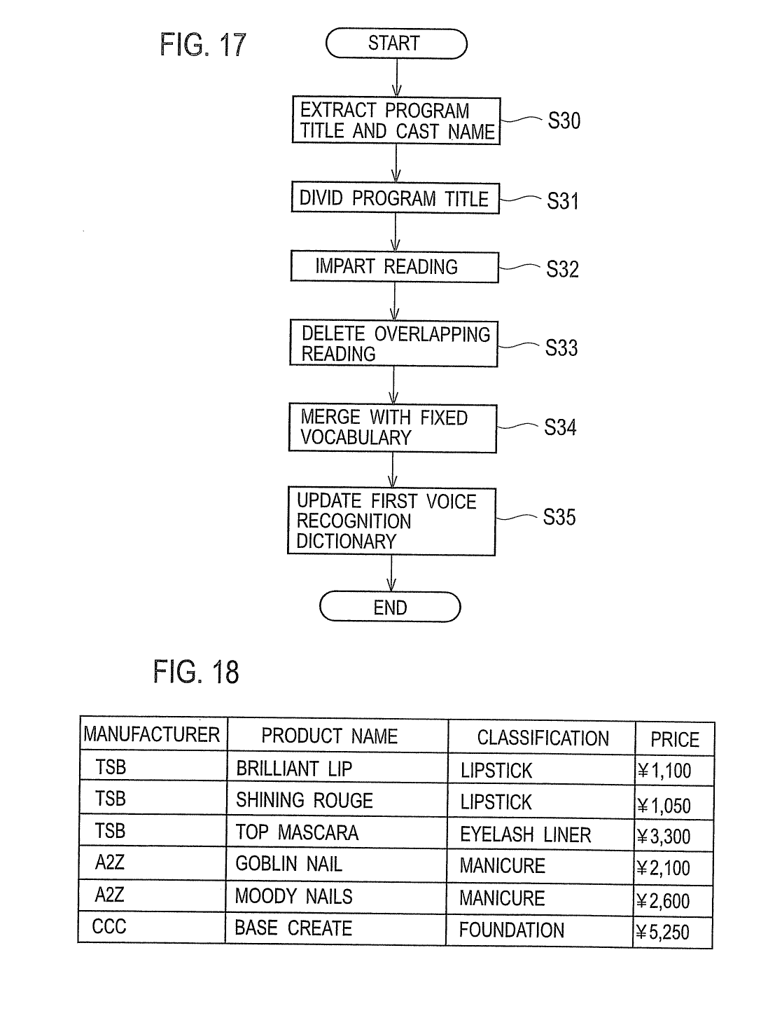

Next, a description will be made of an example of a voice recognition search method according to the embodiment of the present invention while referring to flowcharts of FIGS. 16 and 17.

In step S10, the dictionary creation unit 25 creates the first voice recognition dictionary in accordance with procedures of steps S30 to S35 of FIG. 17. In step S30, the program title and the cast names are extracted from the EPG data stored in the EPG database 31. In step S31, as shown in FIG. 6, the character strings of the program title and the cast names are divided. In step S32, as shown in FIG. 7, the phonetic readings are imparted to the program title and the cast names. In step S33, in order to decrease the number of vocabularies, the overlapping vocabularies having the same phonetic readings are deleted if the vocabularies concerned are present. In step S34, the fixed vocabularies of the categories, the times, the channel names and the like, which are as shown in FIGS. 8 to 10, respectively, and are not be extracted from the program title or the cast names, are added, and the first voice recognition dictionary that is as shown in FIG. 11 is created. In step S35, the first voice recognition dictionary stored in the first dictionary storage unit 23 is updated to the first voice recognition dictionary newly created. The dictionary switching unit 22 sets the first voice recognition dictionary as the voice recognition dictionary that is to be used when the voice recognition unit 21 performs the voice recognition.

In step S11 of FIG. 16, the voice recognition search apparatus 20 waits for a voice recognition starting instruction from the user. A method of the voice recognition starting instruction may be to depress a button (for example, the button 12a) assigned to a function of the voice recognition starting instruction, or may be to depress a button on display arranged on the display unit 27 by using the operation unit 12. After such an instruction to start the voice recognition is issued, with regard to a voice recognition ending instruction, the voice recognition may be automatically ended in such a manner that the voice recognition unit 21 detects a silent section that occurs after the voice is inputted, or the voice recognition may be implemented while the button to start the voice recognition is being depressed. In step S12, after the voice recognition starting instruction, the user speaks the first voice (for example, “Toshiba Taro”) of the program title, the cast name or the like, and inputs this voice to the voice input unit 11. In step S13, the voice recognition is ended.

In step S14, the voice acquisition unit 34 acquires the first voice. The voice recognition unit 21 performs the voice recognition for the first voice, which is acquired by the voice acquisition unit 34, by using the first voice recognition dictionary stored in the first dictionary storage unit 23. Then, the voice recognition unit 21 converts the first voice into the text to thereby create the first text data. In the case where the plurality of voice recognition candidates (first text data) are extracted, the voice recognition unit 21 allows the candidate display unit 26 to display the voice recognition candidates thereon in order from one having a higher likelihood as shown in FIG. 12.

In step S15, in the case where the desired voice recognition candidate is present among the voice recognition candidates displayed on the candidate display unit 26, the user selects the desired voice recognition candidate by the operation unit 12. The instruction acquisition unit 33 acquires the desired voice recognition candidate, and the method proceeds to step S16. Meanwhile, in step S15, in the case where the user does not select the desired voice recognition candidate, and the instruction acquisition unit 33 does not acquire the desired voice recognition candidate, for example, for a fixed time, then the method returns to step S11, and the voice recognition search apparatus 20 waits for the voice recognition starting instruction in order to receive the voice again.

In step S16, the first search unit 28 searches the EPG data, which is stored in the EPG database 31, for the desired voice recognition candidate (first text data) as the first search keyword, which is acquired by the instruction acquisition unit 33. The first search unit 28 determines whether the first search keyword is the cast name or a part thereof or the program title or a part thereof based on the identifier of the first search keyword, searches corresponding spots in the EPG data, extracts the hit programs together with the program broadcast dates and times, the channels, the program titles and the like, and creates the program candidate list. In step S17, the first search unit 28 allows the display unit 27 to display thereon the program candidate list created as shown in FIG. 14. Moreover, the candidate recommendation unit 30 analyzes the program candidate list created by the first search unit 28, and recommends the narrowing candidates as shown in FIG. 14. Note that, in the case where one voice recognition candidate is extracted in step S15, or in the case where the likelihood of one voice recognition candidate is obviously higher than those of the other voice recognition candidates, then in step S16, the first search unit 28 may immediately implement the search for the one voice recognition candidate taken as the first search keyword without waiting for the instruction acquisition unit 33 to acquire the desired voice recognition candidate.

In step S18, the dictionary creation unit 25 creates the second voice recognition dictionary from the program candidate list created by the first search unit 28. The creation method of the second voice recognition dictionary is different from that of the first voice recognition dictionary in the following point. Specifically, the first voice recognition dictionary is created from the programs in the EPG data of the EPG database 31, whereas the second voice recognition dictionary is created from the programs in the program candidate list created by the first search unit 28. Other procedures in the creation method of the second voice recognition dictionary are substantially similar to the procedures in the creation method of the first voice recognition dictionary shown in FIG. 6. Accordingly, a duplicate description will be omitted.

After the program candidate list is created by the first search unit 28, in step S19, the dictionary switching unit 22 switches the voice recognition dictionary, which is to be used for the voice recognition, from the first voice recognition dictionary to the second voice recognition dictionary.

In step S20, in the case where the user selects the desired program from the program candidate list, which is displayed on the display unit 27, by an operation using the operation unit 12, and the instruction acquisition unit 33 acquires the desired program, then the method proceeds to step S29. In step S29, the display unit 27 displays detailed information of the desired program acquired by the instruction acquisition unit 33. The user confirms the detailed information of the program, and then can easily perform programming to record the program by depressing a recording programming button displayed on the display unit 27, and so on. Meanwhile, in step S20, in the case where the user does not select the desired program, and the instruction acquisition unit 33 does not acquire the desired program, for example, for a fixed time, then the method proceeds to step S21.

In step S21, the voice recognition search apparatus 20 turns to a state of waiting for the start of the voice recognition. In step 322, the user speaks the second voice (for example, “variety”), and inputs the second voice to the voice input unit 11. The voice recognition is ended in step S23, and thereafter, in step S24, the voice recognition unit 21 performs the voice recognition by using the second voice recognition dictionary, converts the second voice into the text to thereby create the voice recognition candidate (second text data), and displays the voice recognition candidate on the candidate display unit 26.

In step S25, in the case where the desired voice recognition candidate is present among the voice recognition candidates displayed on the candidate display unit 26, the user selects the desired voice recognition candidate by the operation unit 12. The instruction acquisition unit 33 acquires the desired voice recognition candidate, and the method proceeds to step S26. Meanwhile, in step S25, in the case where the user does not select the voice recognition candidate, and the instruction acquisition unit 33 does not acquire the desired voice recognition candidate, for example, for a fixed time, then the method proceeds to step S21, and the voice recognition search apparatus 20 waits for the voice recognition starting instruction in order to receive the second voice again.

In step S26, the second search unit 29 searches the program candidate list (search results), which is created by the first search unit 28, for the desired voice recognition candidate (second text data) as the second search keyword, which is acquired by the instruction acquisition unit 33. The second search unit 29 determines whether the second search keyword is the cast name or a part thereof or the program title or a part thereof based on the identifier of the second search keyword, searches corresponding spots in the program candidate list created by the first search unit 28, extracts the hit programs together with the program broadcast dates and times, the channels, the program titles and the like, and creates the program candidate list. In step S27, the second search unit 29 allows the display unit 27 to display thereon the program candidate list created as shown in FIG. 15. Note that, in the case where one voice recognition candidate is extracted in step S25, or in the case where the likelihood of one voice recognition candidate is obviously higher than those of the other voice recognition candidates, then in step S26, the second search unit 29 may immediately implement the search for the one voice recognition candidate taken as the first search keyword without waiting for the instruction acquisition unit 33 to acquire the desired voice recognition candidate.

In step S28, in the case where the user selects the desired program from the program candidate list, which is displayed on the display unit 27, by an operation using the operation unit 12, and the instruction acquisition unit 33 acquires the desired program, then the method proceeds to step S29. In step S29, the display unit 27 displays detailed information of the desired program acquired by the instruction acquisition unit 33. The user confirms the detailed information of the program, and then can easily perform the programming to record the program by depressing the recording programming button displayed on the display unit 27, and so on.

Meanwhile, in step S28, in the case where the user does not select the desired program, and the instruction acquisition unit 33 does not acquire the desired program, then the method returns to step S21. In step S21, the voice recognition search apparatus 20 waits for the voice recognition starting instruction in order to receive the second voice again.

In accordance with the embodiment of the present invention, the first voice recognition dictionary, which is to be used for the voice recognition, is appropriately updated in response to the program information (search subject data) updated daily, whereby the voice recognition can be improved.

Moreover, in the case where a large number of the search results are present, it is difficult to find the desired information only by the operation. However, the second voice recognition dictionary is created in response to the search results made by the first search unit 28, the voice recognition is performed by using the second voice recognition dictionary, and the narrowing search is performed for the search results made by the first search unit 28, whereby the voice recognition dictionary is switched to the voice recognition dictionary optimum for the narrowing, and the improvement of the voice recognition accuracy at the narrowing time and the improvement of the usability of the system as a whole can be provided.

Note that a threshold value may be preset for the number of program candidates displayed on the display unit 27, and narrowing of the program candidates may be further implemented in the case where the number of program candidates exceeds the threshold value at the time when the program candidate list is displayed on the display unit 27 in step S27. In this case, the dictionary creation unit 25 may create a new voice recognition dictionary, which is to be used by the voice recognition unit 21, from the program candidate list created by the second search unit 29, the voice recognition unit 21 may perform the voice recognition by using the new voice recognition dictionary, and the second search unit 29 may search the program candidate list created last time. Moreover, the voice recognition by the voice recognition unit 21, the creation of the voice recognition dictionary by the dictionary creation unit 25 and the narrowing search by the second search unit 29 may be repeated until the number of program candidates displayed on the display unit 27 becomes smaller than the threshold value.

### (Program)

The series of procedures shown in FIG. 16 can be achieved by controlling the voice recognition search apparatus shown in FIG. 1 by means of a program having an algorism equivalent to that of FIG. 16. The procedures shown in FIG. 16 include: instructions for creating the first voice recognition dictionary dynamically based on search subject data which is sequentially updated stored in the search subject data storage unit 31; instructions for inputting the first voice; instructions for creating the first text data by recognizing the first voice using the first voice recognition dictionary and convert the first voice into the text; instructions for searching the search subject data by the first text data as the first search keyword; and instructions for displaying the search results on the display unit 27.

The program may be stored in a memory (not shown) of the voice recognition search apparatus of the present invention.

The program can be stored in a computer-readable storage medium. The procedures of the method according to the embodiment of the present invention can be performed by reading the program from the computer-readable storage medium to the memory of the voice recognition search apparatus.

### Other Embodiment

Various modifications will become possible for those skilled in the art after receiving the teachings of the present disclosure without departing from the scope thereof.

The description has been made above of the embodiment of the present invention by taking the program search and the programming to record the program, which use the EPG data, as examples. However, processes similar to those of the embodiment are also applicable to Internet shopping and the like. FIG. 18 is an example of commercial article information data in Internet shopping for cosmetics. For example, if phonetic readings are imparted to all of the respective items in a table of FIG. 18, and are registered in the first voice recognition dictionary, then the voice recognition input and the search are enabled in accordance with manufacturers' names, names of commercial articles, types and prices (in the case of the prices, a range is designated by combining the voice recognition with the operation), and candidates can be further narrowed and decreased from search results, and so on. As described above, the flowchart of FIG. 16 can be directly applied to the Internet shopping. Currently, the Internet shopping is performed mainly by using a personal computer and a cellular phone. However, for users who cannot operate these information terminals well, a function that desired commercial articles can be browsed and ordered by the voice recognition is extremely effective.

What is claimed is:

1. A voice recognition search apparatus comprising:
a search subject data storage unit configured to store search subject data being updated;
a dictionary create unit configured to create a first voice recognition dictionary from the search subject data dynamically;
a voice acquisition unit configured to acquire first and second voices;
a voice recognition unit configured to create first text data by recognizing the first voice using the first voice recognition dictionary and converting the first voice into a text, and configured to create second text data by recognizing the second voice using a second voice recognition dictionary and converting the second voice into a text;
a first search unit configured to search the search subject data by the first text data as a first search keyword; and
a second search unit configured to search a search result of the first search unit by the second text data as a second search keyword.

2. The apparatus of claim 1, wherein the dictionary create unit creates the first voice recognition dictionary by combining vocabularies dynamically created from the search subject data and fixed vocabularies with each other.

3. The apparatus of claim 1, wherein the dictionary create unit creates the second voice recognition dictionary based on the search result.

4. The apparatus of claim 1, wherein the dictionary create unit creates the second voice recognition dictionary by combining vocabularies created from the search result and fixed vocabularies with each other.

5. The apparatus of claim 1, wherein the second voice recognition dictionary is composed of fixed vocabularies.

6. The apparatus of claim 1, further comprising:
a dictionary switching unit configured to switch a voice recognition dictionary being used by the voice recognition unit from the first voice recognition dictionary to the second voice recognition dictionary when the display unit displays the search result.

7. The apparatus of claim 1, further comprising:
a candidate recommendation unit configured to recommend a candidate of the second voice effective in search by the second search unit based on the search result.

8. A voice recognition search method comprising:
creating a first voice recognition dictionary dynamically based on search subject data being updated sequentially stored in a search subject data storage unit;
acquiring first and second voices;
creating first text data by recognizing the first voice using the first voice recognition dictionary and converting the first voice into a text;
creating second text data by recognizing the second voice using a second voice recognition dictionary and converting the second voice into a text;
searching the search subject data by the first text data as a first search keyword; and
searching a search result of the first search keyword by the second text data as a second search keyword.

9. The method of claim 8, wherein creating the first voice recognition dictionary comprises creating the first voice recognition dictionary by combining vocabularies dynamically created from the search subject data and fixed vocabularies with each other.

10. The method of claim 8, further comprising:
creating the second voice recognition dictionary based on the search result.

11. The method of claim 8, further comprising:
creating the second voice recognition dictionary by combining vocabularies created from the search result and fixed vocabularies with each other.

12. The method of claim 8, wherein the second voice recognition dictionary is composed of fixed vocabularies.

13. The method of claim 8, further comprising:
switching a voice recognition dictionary being used in a voice recognition from the first voice recognition dictionary to the second voice recognition dictionary when the search result are displayed.

14. The method of claim 8, further comprising:
recommending a candidate of the second voice effective in search by the second search keyword based on the search result.
